(19) United States
(12) Patent Application Publication
(10) Pub. No.: US 2006/0099999 A1
(43) Pub. Date: May 11, 2006

(54) Connector for charging cellular phone

(76) Inventor: Young-Tae Park, Gyenggi-do (KR)

Correspondence Address: SYNNESTVEDT LECHNER & WOODBRIDGE LLP, P O BOX 592, PRINCETON, NJ, 08542-0592, US

(21) Appl. No.: 10/524,683

(22) PCT Filed: Sep. 7, 2002
(86) PCT No.: PCT/KR02/01685

§ 371 Date: Feb. 15, 2005

(30) Foreign Application Priority Data
Aug. 17, 2002 (KR) 2002-0024549 U

(51) Int. Cl. H04M 1/00; H04B 1/38

(52) U.S. Cl. 455/573; 455/572

(57) ABSTRACT

The present invention relates to a connector for charging a mobile phone, for example a cellular phone in which a charging state can be acknowledged by a light emitting element that changes its color according to an amount of a charging voltage. Furthermore, the present invention relates to a connector for charging a mobile phone in which a light emitting element is covered with a window so that the light emitting element can be protected from an outer impact not to be broken.

### TECHNICAL FIELD

The present invention relates to a connector for charging a mobile phone, for example a cellular phone in which a charging state can be acknowledged by a light emitting element that changes its color according to an amount of a charging voltage.

Furthermore, the present invention relates to a connector for charging a mobile phone in which a light emitting element is covered with a window so that it can be protected from an outer impact not to be broken.

### BACKGROUND ART

Recently, mobile phones are widely used. In case when the mobile phone should be charged, two kinds of products are needed such as an adapter and a connector. The adapter serves to convert an alternate current voltage to a direct current voltage and the connector serves to supply the DC voltage to the mobile phone. The connector is disposed between the adapter and the mobile phone.

However, a conventional connector serves only as a passage for supplying the charging voltage to the mobile phone. Accordingly, in case when the mobile phone is not charged perfectly because of some defects of the connector, an user can not be acknowledged what the connector has a defect. Furthermore, the conventional connector for charging has a light emitting element for displaying the state of charging according to an amount of a charging voltage. However, the conventional light emitting element is disposed at the connector to be protruded outside, thereby causing the light emitting element to be broken due to an outer impact.

### SUMMARY OF THE INVENTION

The present invention has been invented to overcome the above conventional disadvantages and it is an object of the present invention to provide a connector for charging a mobile phone in which a charging state can be acknowledged by a light emitting element that changes its color according to an amount of a charging voltage.

Other object of the present invention is to provide a connector for charging a mobile phone in which a light emitting element is covered with a window so that it can be protected from an outer impact not to be broken.

In order to achieve above objects, the present invention provides a connector for charging a mobile phone comprising a connecting terminal that formed to be protruded outside from a body for coupling or separating to or from a mobile phone by a projection in a groove, the projection formed, as one body, with an adjustment portion adjusting by an user, and upper and lower covers coupled by a bolt through a bolt inserting groove, wherein said connector comprises a light emitting element disposed on a printed circuit board that electrically connected to the mobile phone by a pin, the light emitting element changing its color yellow, red and green in order according to an amount of a charging voltage so that the user can acknowledge the state of charging.

The light emitting element is disposed on the print circuit board by the pin for electrically connecting to the mobile phone.

The upper cover forms a hole at its a certain portion for securing a window by an ultrasonic and a thermal fusion manners.

### BRIEF DESCRIPTION OF THE DRAWINGS

FIG. 1 is a front view of a connector for charging a mobile phone according to the present invention.

FIG. 2 is an inside view of a connector for charging a mobile phone according to the present invention.

FIG. 3 is a rear view of a connector for charging a mobile phone according to the present invention.

FIG. 4 is a partial sectional view of a connector for charging a mobile phone according to the present invention.

### DISCLOSURE OF INVENTION

A detailed description of the invention will now be described with reference to the accompanying drawings.

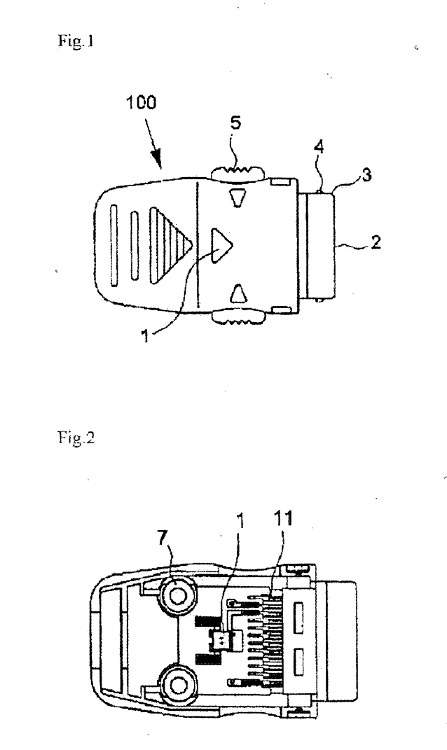

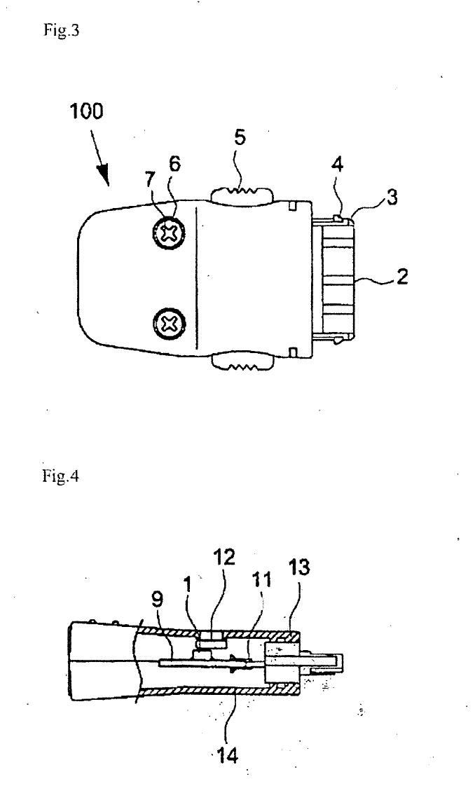

FIG. 1 is a front view of a connector for charging a mobile phone according to the present invention, FIG. 2 is an inside view of a connector for charging a mobile phone according to the present invention, FIG. 3 is a rear view of a connector for charging a mobile phone according to the present invention.

As shown in FIGS. 1 to 3, a connector 100 of the present invention is coupled by upper and lower covers 13 and 14. The connector 100 disposes at its central portion with a light emitting element 1 for changing its color according to an amount of a charging voltage of the mobile phone. The light emitting element 1 is fixedly established in the connector 100 by fixing means 8.

The light emitting element 1 is disposed on a printed circuit board 9 that electrically connected to the mobile phone through a pin 11 for being supplied a charging voltage to the mobile phone.

The light emitting element 1 is set to display yellow, red, green in order according to the amount of the charging voltage of the mobile phone. That is, The light emitting element 1 displays the yellow color for a certain time when the connector 100 is initially connected to the mobile phone via the adapter and displays the red color for a certain time and finally displays the green color when the mobile phone is completed its charging.

Furthermore, the connector 100 has a connecting terminal 2 to be protruded outside of the body. The connecting terminal 2 serves to supply the DC voltage outputted from the adapter to the mobile phone in a manner that it is connected to or separated from the mobile phone.

The terminal 2 is coupled to or separated from the mobile phone by [symbol] projection 4 formed in the groove 3. The projection 4 is formed as one body with an [symbol] adjustment portion 5 that adjusting by an user. The adjustment portion 5 serves so that [symbol] the terminal 2 is connected to or separated from the mobile phone in the manner that [symbol] the user adjusts it.

FIG. 4 is a partial sectional view of a connector for charging a mobile phone [symbol] according to the present invention.

The connector 100 of the present invention is as shown in FIG. 4 formed a [symbol] hole 15 at a certain portion of the upper cover 13. The hole 15 is inserted with a [symbol] window 12 for acknowledging an operation state of the light emitting element 1. The [symbol] window 12 is initially secured by an ultrasonic manner or a thermal fusion manner and [symbol] finally secured by a bolt 6 for securing the upper and the lower cover 13 and 14.

Unexplained reference numeral 10 is a connecting portion connected to the [symbol] adapter.

The connector for charging the mobile phone having the above constructions [symbol] is operated as the following.

Under a state that the adapter and the connector 100 are coupled the user [symbol] pushes the adjustment portion 5 to thereby be inserted the projection 4 into the groove [symbol] 3. Then the connecting terminal 2 of the connector 100 is connected to the terminal of [symbol] the mobile phone. Under this state, when the adapter is connected to AC source, AC [symbol] source is converted to DC source by the adapter so that it supply to the connector 100 [symbol] and thereafter to supply to the mobile phone. Therefore, the mobile phone is charged [symbol] and the color of the light emitting element 1 is changed yellow, red, green in order [symbol] according to the amount of the charging voltage.

The user can acknowledge the charging state of the mobile phone by the [symbol] changing of the color of the light emitting element 1 through the window 12.

### INDUSTRIAL AVAILABILITY

As mentioned above the present invention has the advantages as the [symbol] followings.

First, an user can easily acknowledge a charging state of a mobile phone because a light emitting element is changed its color yellow, red and green in order according to an amount of charging voltage to the mobile phone.

Second, the light emitting element is covered with a window so that it can be protected from an outer impact not to be broken.

1. A connector for charging mobile phone comprising a connecting terminal 2 that formed to be protruded outside from a body for coupling or separating to or from a mobile phone by a projection 4 in a groove 3, the projection 4 formed, as one body, with an adjustment portion 5 adjusting by an user, and upper and lower covers 13 and 14 coupled by a bolt 6 through a bolt inserting groove 7, wherein said connector comprises a light emitting element 1 disposed on a printed circuit board that electrically connected to the mobile phone by a pin 11, the light emitting element changing its color yellow, red and green in order according to an amount of a charging voltage so that the user can acknowledge the state of charging.

2. The connector for charging the mobile phone in accordance with claim 1, wherein said light emitting element 1 is disposed on the print circuit board 9 by the pin 11 for electrically connecting to the mobile phone.

3. The connector for charging the mobile phone in accordance with claim 1, wherein said upper cover 13 forms a hole 15 at its a certain portion for securing a window 12 by an ultrasonic and a thermal fusion manners.
